(19) United States
(12) Patent Application Publication
(10) Pub. No.: US 2010/0243151 A1
(43) Pub. Date: Sep. 30, 2010

(54) Coated Label Substrates

(75) Inventor: Bruce G. Stokes, Woodstock, GA (US)

Correspondence Address: DORITY & MANNING, P.A., POST OFFICE BOX 1449, GREENVILLE, SC, 29602-1449, US

(73) Assignee: NEENAH PAPER, INC., Roswell, GA (US)

(21) Appl. No.: 12/411,770

(22) Filed: Mar. 26, 2009

(51) Int. Cl. B32B 33/00; B32B 5/16; B32B 3/10; B32B 37/12

(52) U.S. Cl. 156/277; 428/327; 428/195.1; 428/41.8

(57) ABSTRACT

A coated label substrate including a label substrate, a printable coating, and a connector (e.g., an adhesive layer) is generally provided. The printable coating overlies one surface of the label substrate. The printable coating includes an organic polymer covalently bonded to a plurality of inorganic nanoparticles (e.g., metal oxide nanoparticles such as SiO₂), and is configured to not melt during printing at temperatures up to about 350° F. Other materials, such as an opacifier, may also be present in the printable coating. An ink composition (e.g., toner ink, resin ribbon composition, etc.) can be applied an external surface of the coated label substrate formed by the printable coating to defines an image on the external surface

### BACKGROUND OF THE INVENTION

The increased availability of printers has allowed ordinary consumers to make and print their images on a variety of papers and labels. The ink composition printed according to these processes can vary with the type of printer utilized. No matter, the inks printed onto labels can be exposed to various environments when applied to its labeled product. For example, the label can be exposed to outdoor conditions (e.g., sunlight, moisture, extreme temperatures, etc.). In other environments, the label can be exposed to harsh chemicals. This exposure to some environments can cause the ink to fade and/or be removed from the surface of the label.

Printable surfaces engineered for thermal printing processes (e.g., laser printers) are typically crosslinked polymeric layers that prevent the printable surface from melting during the printing process. The crosslinked polymeric layers have higher melting temperatures enabling them to withstand the elevated printing temperatures. However, the crosslinking typically also leads to higher glass transition temperatures and less affinity of the printable layer for the thermal ink, leading to less durability in the printed material.

Therefore, a need exists for a label having improved printable characteristics and durability of printed inks on the surface of the label.

### SUMMARY OF THE INVENTION

Objects and advantages of the invention will be set forth in part in the following description, or may be obvious from the description, or may be learned through practice of the invention.

A coated label substrate is generally provided according to one embodiment. The coated label substrate comprises a label substrate, a printable coating, and a connector (e.g., an adhesive layer). The printable coating overlies one surface of the label substrate. The printable coating includes an organic polymer covalently bonded to a plurality of inorganic nanoparticles (e.g., metal oxide nanoparticles such as SiO₂), and is configured to not melt during printing at temperatures up to about 350° F. Other materials, such as an opacifier, may also be present in the printable coating. An ink composition (e.g., toner ink, ribbon composition, etc.) can be applied an external surface of the coated label substrate formed by the printable coating to define an image on the external surface

A method of making the coated label substrate is also generally provided. Additionally, a method of labeling a product with a coated label substrate is generally provided.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows an exemplary coated label substrate 10 having a printable coating 18 and an adhesive layer 22 on opposite surfaces side of the label substrate 12;

FIG. 2 shows the exemplary coated label substrate 10 of FIG. 1 attached to a releasable sheet 30;

FIG. 3 shows removal of the releasable sheet 30 from the exemplary coated label substrate 10 of FIG. 2 exposing the adhesive layer 22; and

FIG. 4 shows an ink composition 40 applied to the exemplary coated label substrate 10 of FIG. 1.

Repeat use of reference characters in the present specification and drawings is intended to represent the same or analogous features or elements of the present invention.

### DEFINITIONS

As used herein, the term “printable” is meant to include enabling the placement of an image on a material, especially through the use of laser printers, laser copiers, other toner-based printers and copiers, and thermal transfer printers (e.g., resin ribbon thermal transfer, wax ribbon thermal transfer, and resin/wax thermal transfer). Moreover, the image composition may be composed of any of the inks or other compositions typically used in these printing processes (e.g., toner ink compositions and ribbon compositions).

The term “toner ink” is used herein to describe an ink adapted to be fused to the printable substrate with heat.

As used herein, the term “cellulosic nonwoven web” is meant to include any web or sheet-like material which contains at least about 50 percent by weight of cellulosic fibers. In addition to cellulosic fibers, the web may contain saturants and/or other natural fibers, synthetic fibers, or mixtures thereof. Cellulosic nonwoven webs may be prepared by air laying or wet laying relatively short fibers to form a web or sheet. Thus, the term includes nonwoven webs prepared from a papermaking furnish. Such furnish may include only cellulose fibers or a mixture of cellulose fibers with other natural fibers and/or synthetic fibers. The furnish also may contain additives and other materials, such as fillers, e.g., clay and titanium dioxide, surfactants, antifoaming agents, and the like, as is well known in the papermaking art.

As used herein, the term “polymeric film” is meant to include any sheet-like polymeric material that is extruded or otherwise formed (e.g., cast) into a sheet. Typically, polymeric films do not contain discernable fibers.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

The term “thermoplastic” is used herein to mean any material formed from a polymer which softens and flows when heated; such a polymer may be heated and softened a number of times without suffering any basic alteration in characteristics, provided heating is below the decomposition temperature of the polymer. Examples of thermoplastic polymers include, by way of illustration only, polyolefins, polyesters, polyamides, polyurethanes, acrylic ester polymers and copolymers, polyvinyl chloride, polyvinyl acetate, etc. and copolymers thereof.

The term “organic” is used herein to pertaining to a class of chemical compounds that are comprised of carbon atoms. For example, an “organic polymer” is a polymer that includes carbon atoms in the polymer backbone.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, the prefix “nano” refers to the nanometer scale (i.e., from about 1 nm to about 999 nm). For example, particles having an average diameter on nanometer scale (i.e., from about 1 nm to about 999 nm) are referred to as “nanoparticles”. Particles having a size of greater than 1,000 nm (i.e., 1 μm) are generally referred to as “microparticles”, since the micrometer scale generally involves those particles having an average diameter of greater than 1 μm.

### DETAILED DESCRIPTION

It is to be understood by one of ordinary skill in the art that the present discussion is a description of exemplary embodiments only, and is not intended as limiting the broader aspects of the present invention, which broader aspects are embodied in the exemplary construction.

Generally speaking, the present invention is directed to printable, coated label substrates that exhibit good durability with respect to the printings on the label, even in harsh environments such as outdoor exposure to sunlight, moisture, etc. Additionally, the print quality formed on the coated label substrates can be of excellent quality such that virtually any image can be printed on the coated label substrates.

### I. Printable Coating

The printable coating can generally be applied to the label substrate in order to form an external, printable surface on the resulting coated label substrate. The printable coating applied to the external surface of the label substrate can improve the printability of the label substrate. Additionally, any printing on the printable coating can be durable and can withstand harsh conditions (e.g., outdoor exposure, exposure to moisture, harsh chemical environments, and the like) and can exhibit an increased scratch and abrasion resistance. Thus, the printed label can have increased durability in a variety of environments.

The printable coating can be formed by applying a polymeric emulsion to the surface of the label substrate, followed by drying. The printable coating can act as an anchor to hold the printed image on the coated label substrate. The printable coating can generally include an organic polymer covalently bonded to inorganic particles. Suitable organic polymers include, but are not limited to, polyamides, polyolefins, polyesters, polyurethanes, poly(vinyl chloride), poly(vinyl acetate), polyethylene oxide, polyacrylates, polystyrene, polyacrylic acid, and polymethacrylic acid. Copolymers and mixtures thereof also can be used. As a practical matter, water-dispersible ethylene-acrylic acid copolymers have been found to be particularly effective organic polymers for use in forming the printable coating.

In one particular embodiment, the organic polymer can be “polar” in nature. Polymers containing carboxy groups, for instance, can be utilized as polar polymers. The presence of carboxy groups can readily increase the polarity of a polymer due to the dipole created by the oxygen atom. For example, in some embodiments, carboxylated (carboxy-containing) polyacrylates can be used as the organic polymer. Also, other carboxy-containing polymers can be used, including carboxylated nitrile-butadiene copolymers, carboxylated ethylene-vinylacetate copolymers, and carboxylated polyurethanes.

In one embodiment, the polar organic polymer can be an acrylic latex binder. Suitable polyacrylic latex binders can include polymethacrylates, poly(acrylic acid), poly(methacrylic acid), and copolymers of the various acrylate and methacrylate esters and the free acids; ethylene-acrylate copolymers; vinyl acetate-acrylate copolymers, and the like.

The organic polymer of the printable coating can be provided in an emulsion having from about 5% to about 60% solids by weight, such as from about 25% to about 50% by weight.

No matter the particular organic polymer utilized in the printable coating, an inorganic nanoparticle is covalently bonded to the organic polymer. The inorganic nanoparticle can be, in one particular embodiment, a metal-oxide nanoparticle, such as silicon dioxide (SiO₂), aluminum oxide (Al₂O₃), aluminum dioxide (AlO₂), zinc oxide (ZnO), and combinations thereof. The inorganic nanoparticles can have an average diameter on the nanometer scale, such as from about 1 nm to about 500 nm, and such as about 10 nm to about 250 nm. In one particular embodiment, the inorganic nanoparticles can have an average diameter from about 10 nm to about 100 nm.

The inorganic nanoparticle can be covalently bonded to the organic polymer through polymerization in the presence of the nanoparticle. For example, an organic polymer covalently bonded to the SiO₂ nanoparticle can be formed through emulsion polymerization, including but not limited to (a) emulsion polymerization carried out in the presence of colloidal silica gel compositions, or (b) emulsion polymerization carried out in the presence of colloidal silica gel compositions having a functionalized surface. When the colloidal silica gel particles and the organic polymer both have functionalized surfaces, prior to polymerization, the particles can be covalently bonded together resulting in a polymer matrix having the particles substantially evenly distributed throughout the resulting polymer matrix. This polymer matrix can then be used to create a smooth printable coating.

In one particular embodiment, SiO₂ nanoparticles can be covalently bonded to acrylic polymers by introducing SiO₂ nanoparticles formed in-situ hydrolysis of tetraethylorthosilicate in emulsion polymerization. Another exemplary polymerization technique utilizes a polymerizable silane (e.g., methacryloxypropyl trimethoxy silane, or TMS) and a methacrylate-terminated macromer as a coupling agents. A wide range of polymer morphologies can be obtained depending on the synthesis strategy. For instance, the anchoring TMS monomer can be reacted on the silica particle surface via silanol functionality.

The covalently bonded inorganic nanoparticles in the printable coating can allow for a more uniform distribution of the nanoparticles in the coating, which can be particularly apparent in those embodiments utilizing relatively small nanoparticles (e.g., average diameter from about 10 nm to about 100 nm) covalently bonded to the polymer. Without wishing to be bound by theory, the presence of the covalent bonding between the inorganic nanoparticles and the organic polymer in the printable coating can reduce the tendency of the nanoparticles in the printable coating to agglomerate. Thus, a smooth, uniform printable surface can be formed.

The upper limit for the amount of inorganic nanoparticles included in the coating is generally determined by the amount of nanoparticles that can be covalently bonded to the organic polymer. For example, the inorganic nanoparticles bonded to the organic polymer can make up from about 1% to about 50% of the total weight of the polymer, such as from about 10% to about 45%. In one particular embodiment, the nanoparticles bonded to the polymer can make up from about 25% to about 45% of the total weight of the polymer.

A suitable printable coating organic polymer covalently bonded to inorganic nanoparticies can be formed from an acrylic emulsion polymer having 40% by weight SiO₂ nanoparticles covalently bonded to the acrylic polymer backbone, such as the polymer commercially available under the name Celvolit 9420 from Celanese Emulsion Polymers (Dallas, Tex.).

Without wishing to be bound by theory, it is believed that the inorganic nanoparticles add affinity for the inks of the printed image to the printable coating. For example, it is believe that metal-oxide nanoparticles (e.g., SiO₂) can add an available bonding site at the oxide that can bond (covalent bonds or ionic bonds) and/or interact (e.g., van der Waals forces, hydrogen bonding, etc.) with the ink binder and/or pigment molecules in the ink. This bonding and/or interaction between molecules of the ink composition and the oxide of the nanoparticles can improve the durability of the ink printed on the printable surface.

The inorganic nanoparticles can also reduce the thermoplastic behavior of the base organic polymer(s) of the printable coating. As such, the printable coating including the organic polymer bonded to the inorganic nanoparticies will have less thermoplastic behavior, which can allow its use as a printable coating in a thermal printing process even if the base polymer (without any inorganic particles present) would ordinary melt at the printing temperatures. Specifically, once dried, the printable coating does not appreciably soften and/or melt at temperatures encountered in the printing process (e.g., the fusing temperatures of laser printers/copiers or the thermal ribbon transfer temperatures). Thus, the melting point and melting characteristics of the organic polymer have been altered due to the presence of the covalently bonded inorganic nanoparticles, and the resulting printable coating does not appreciably melt or flow at printing process temperatures, such as up to about 400° F. (e.g., up to about 350° F.). Even at 400° F., the printable coating does not become tacky and does not stick to printer or other parts involved in the printing process. Without wishing to be bound by theory, it is believed that the covalently bonded inorganic nanoparticles limit movement of polymer once dried as the printable coating. It seems that the hardness of the inorganic limits the thermoplastic nature of the organic polymer.

This change in melting characteristics is achieved without crosslinking of the organic polymer to form the printable coating. Thus, the printable coating can be substantially free from crosslinking between polymers. As such, the printable coating can be free from any crosslinking agent and/or any curing agent.

Additionally, the change in melting characteristics can be achieved without significantly raising the glass transition temperature (T_{g}) of the printable coating polymer. Relatively low glass transition temperatures allow for the printable coating to remain flexible both before and after printing. Generally, the more inorganic nanoparticles included in the organic polymer leads to an effective higher glass transition temperature due to the restricted mobility of the polymer chains near the polymer-nanoparticle interface. Again, however, once dried the printable coating exhibits melting and/or flowing characteristics above elevated temperatures encountered during printing, but can remain a flexible coating.

Other additives, such as processing agents, may also be present in the printable coating, including, but not limited to, thickeners, dispersants, emulsifiers, viscosity modifiers, humectants, etc. Surfactants can also be present in the printable coating to help stabilize the emulsion prior to and during application. For instance, the surfactant(s) can be present in the printable coating up to about 20%, such as from about 2% to about 15%. Exemplary surfactants can include nonionic surfactants, such as a nonionic surfactant having a hydrophilic polyethylene oxide group (on average it has 9.5 ethylene oxide units), a cationic surfactant, and/or a anionic surfactant, such as available commercially as Tamol 731A (Rohm & Haas Co., Philadelphia, Pa.). In one particular embodiment, a combination of at least two surfactants can be present in the printable coating.

Viscosity modifiers can be present in the printable coating. Viscosity modifiers are useful to control the rheology of the coatings in their application. For example, sodium polyacrylate (such as Paragum 231 from Para-Chem Southern, Inc., Simpsonville, S.C.) may be included in the printable coating. The viscosity modifier can be included in any amount, such as up to about 5% by weight, such as about 1% to about 4% by weight.

Additionally, pigments and other coloring agents may be present in the printable coating such that the printable coating provides a background color to the coated label substrate. For example, the printable coating may further include an opacifier with a particle size and density well suited for light scattering (e.g., aluminum oxide particles, titanium oxide particles, and the like). These opacifiers may be additional metal-oxide particles that are not bonded (i.e., not covalently bonded to the polymer) within the polymer matrix of the printable coating. These opacifiers can be present in the printable coating from about 0.1% by weight to about 25% by weight, such as from about 1% by weight to about 10% by weight.

When it is desired to have a relatively clear or transparent printable coating, the printable coating can be substantially free from pigments, opacifying agents, and other coloring agents (e.g., free from metal particles, metalized particles, clay particles, etc.) other than the inorganic nanoparticles bonded the organic polymer. In these embodiments, the underlying label substrate can be seen through the printable coating, except where an image is printed on the printable coating.

The printable coating may be applied to the label substrate by known coating techniques, such as by roll, blade, Meyer rod, and air-knife coating procedures. Alternatively, the printable coating may be a film laminated to the label substrate. The resulting coated label substrate then may be dried by means of, for example, steam-heated drums, air impingement, radiant heating, or some combination thereof. Likewise, the adhesive layer may be applied to the opposite surface of the label substrate by any technique.

The basis weight of the printable coating generally may vary from about 2 to about 70 g/m², such as from about 3 to about 50 g/m². In particular embodiments, the basis weight of the printable coating may vary from about 5 to about 40 g/m², such as from about 7 to about 25 g/m².

### II. Label Substrates

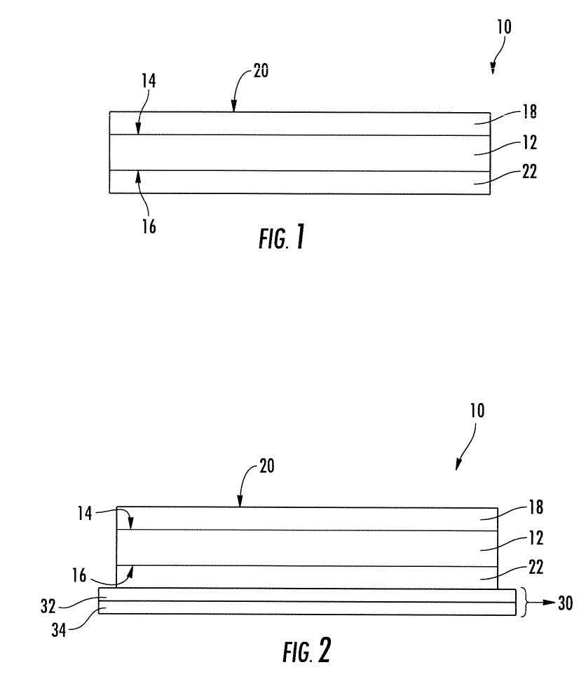

FIG. 1 shows an exemplary coated label substrate 10 having a printable coating 18 as described above. The printable coating 18 defines an external, printable surface 20 of the coated label substrate 10. The printable coating 18 is shown overlying the first surface 14 of the label substrate 12, and the adhesive layer 22 is shown overlying the opposite, second surface 16 of the label substrate 12. Although shown with an adhesive layer, the coated label substrate 10 can employ any available connector to attach the coated label substrate to the material/product to be labeled. Other suitable connectors include, for example, ties (e.g., wires, cords, strings, ropes, and the like), tape (e.g., the use of tape to secure the label substrate to the product), etc.

The printable coating 18 is shown in the exemplary embodiment of FIG. 1 as directly overlying the first surface 14 of the label substrate 12 (i.e., no intermediate layer exists between the first surface 14 of the label substrate 12 and the printable coating 18). Likewise, the adhesive layer 22 is shown in the exemplary embodiment of FIG. 1 as directly overlying the second surface 16 of the label substrate 12 (i.e., no intermediate layer exists between the second surface 16 of the label substrate 12 and the adhesive layer 22). In other embodiments, however, an intermediate layer(s) could be present between the label substrate 12 and the printable surface 20 and/or between the label substrate 12 and the adhesive layer 22. For example, a tie layer may be present between the label substrate 12 and the adhesive layer 22.

The label substrate is generally flexible and has first and second surfaces. For example, the label substrate can be a film or a cellulosic nonwoven web. In addition to flexibility, the label substrate also provides strength for handling, coating, sheeting, and other operations associated with the manufacture thereof. The basis weight of the label substrate generally may vary, such as from about 30 to about 250 g/m². Suitable label substrates include, but are not limited to, cellulosic nonwoven webs and polymeric films. In one particular embodiment, the label substrate comprises a paper web. A number of different types of paper are suitable for the present invention including, but not limited to, common litho label paper, bond paper, and latex saturated papers. In alternative embodiments, the label substrate can comprise a polymeric film. One particularly suitable polymeric film useful as a label substrate is a bi-axially oriented polypropylene (BOPP) film available commercially under the name Kimdura® FPG-95 from Neenah Paper, Inc. (Alpharetta, Ga.).

The adhesive layer can be a pressure sensitive adhesive, a glue applied or wet adhesive, or any other type of suitable adhesive material. For example, the adhesive layer can include natural rubber, styrene-butadiene copolymers, acrylic polymers, vinyl-acetate polymers, ethylene vinyl-acetate copolymers, and the like.

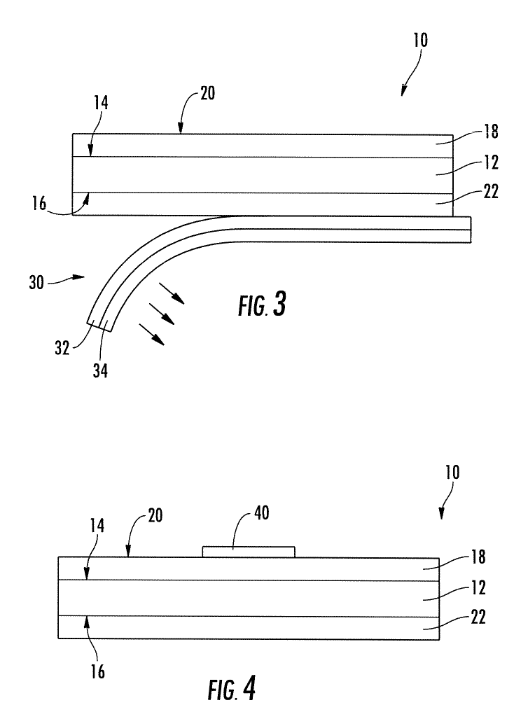

FIGS. 2 and 3 show a releasable sheet 30 can be attached to the coated label substrate 10 to protect the adhesive layer 22 until the coated label substrate 10 is to be applied to its final surface. The releasable sheet 30 includes a release layer 32 overlying a base sheet 34. The release layer 32 allows the releasable sheet 30 to be released from the coated label substrate 10 to expose the adhesive layer 22 such that the coated label substrate 10 can be adhered to its final surface via the adhesive layer 22

The base sheet 34 of the releasable sheet 30 can be any film or web (e.g., a paper web). For example, the base sheet 34 can be generally manufactured from any of the materials described above with regards to the label substrate.

The release layer 32 is generally included to facilitate the release of the releasable sheet 30 from the adhesive layer 22. The release layer 32 can be fabricated from a wide variety of materials well known in the art of making peelable labels, masking tapes, etc. Although shown as two separate layers in FIGS. 2-3, the release layer 32 can be incorporated within the base sheet 34, so that they appear to be one layer having release properties.

To apply the label to a surface, the releasable sheet is first separated from the coated label substrate to expose the adhesive layer of the coated label substrate. The releasable sheet can be discarded and the coated label substrate can be adhered to a surface via the adhesive layer.

Ill. Printing onto the Printable Coating of the Coated Label Substrate

An image can be formed on the printable coating of the coating label substrate by printing an ink composition onto the printable coating. In particular, thermal printing methods can print the ink composition to the printable coating, such as toner-based printers and copiers, ribbon printers, etc. Thermal printing methods generally involve the application of heat to soften and bond the ink composition to the printable coating. In toner printing processes, the application of heat fuses the toner ink to the printed surface. In ribbon printing (e.g., resin ribbon printing, wax ribbon printing, and combinations thereof), the transfer of the ink composition—the ribbon—is achieved at elevated temperatures.

FIG. 4 shows an ink composition 40 on the printable coating 18 of the coated label substrate 10. The ink composition can form any desired image desired on the printable coating. Typically, the composition of the ink composition will vary with the printing process utilized, as is well known in the art.

The present invention may be better understood with reference to the following examples.

### EXAMPLES

The following examples are provided to show an exemplary application of a coated label substrate.

### Example 1

Sheets of a saturated label base sold under the designation Grade Specification 0101B0, having a basis weight of 67 gsm by (Neenah Paper, Inc., Alpharetta, Ga.) were coated with 12 gsm of an acrylic emulsion polymer having 40% by weight SiO₂ nanoparticles covalently bonded to the acrylic polymer backbone available under the name Celvolit 9420 from Celanese Emulsion Polymers (Dallas, Tex.). The coated sheet was dried in an oven at 105° C.

Samples of the coated labels were printed on the coating surface using three different laser printers: HP 3600 (Hewlett Packard Company, Palo Alto, Calif.), Phaser 6180 (Xerox Corp., Norwalk, Conn.), and OKI 5150 (Oki Data Americas, Inc, Mount Laurel, N.J.). The coated samples were all printed with good image quality. Toner bonding was excellent such that the printed coated samples exhibited good durability, as tested by a finger nail scratch and applying then removing an adhesive pressure-based tape (Scotch® Tape, 3M Corp., St. Paul, Minn.).

### Example 2

Sheets of a 73 gsm BOPP film (available under the name Kimdura® FPG-95 from Neenah Paper, Inc., Alpharetta, Ga.) were coated with 15 gsm of an acrylic emulsion polymer having 40% by weight SiO₂ nanoparticles covalently bonded to the acrylic polymer backbone available under the name Celvolit 9420 from Celanese Emulsion Polymers (Dallas, Tex.). The coated sheet was dried in an oven at 105° C.

Samples of the coated sheets were tested for thermal transfer printability with thermal transfer resin ribbons by Intermec, Inc. (Everett, Wash.). The test results showed excellent print quality with the Resin Ribbons TMX3201 and TMX3202 (Intermec, Inc. Everett, Wash.). Print durability was shown to be dramatically above standard mid-range films, such as the label available commercially as Smudge-proof Kimdura® from Neenah Paper, Inc. (Alpharetta, Ga.).

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed:

1. A coated label substrate comprising
a label substrate defining a first surface and a second surface;
a printable coating overlying the first surface of the label substrate, wherein the printable coating an organic polymer covalently bonded to a plurality of inorganic nanoparticles; wherein the printable coating does not melt during printing at temperatures up to about 350° F.; and
a connector configured to attach the label substrate to a product for labeling.

2. The coated label substrate as in claim 1, wherein the inorganic nanoparticles comprise metal-oxide nanoparticles.

3. The coated label substrate as in claim 2, wherein the metal-oxide nanoparticles comprise silicon dioxide nanoparticles.

4. The coated label substrate as in claim 1, wherein the inorganic nanoparticles have an average diameter of from about 1 nanometer to about 500 nanometers.

5. The coated label substrate as in claim 1, wherein the inorganic nanoparticles have an average diameter of from about 10 nanometers to about 100 nanometers.

6. The coated label substrate as in claim 1, wherein the printable coating further comprises an opacifier.

7. The coated label substrate as in claim 6, wherein the opacifier comprises metal-oxide particles.

8. The coated label substrate as in claim 6, wherein the opacifier comprises titanium dioxide particles.

9. The coated label substrate as in claim 6, wherein the opacifier is present in the printable coating from about 0.1% by weight to about 25% by weight.

10. The coated label substrate as in claim 1, wherein the inorganic nanoparticles covalently bonded to the polymer comprise from about 1% to about 50% of the polymer by weight.

11. The coated label substrate as in claim 1, wherein the label substrate comprises a polymeric film.

12. The coated label substrate as in claim 1, wherein the label substrate comprises a saturated cellulosic nonwoven web.

13. The coated label substrate as in claim 1, further comprising an ink composition applied an external surface of the coated label substrate formed by the printable coating, wherein the ink composition defines an image on the external surface.

14. The coated label substrate as in claim 13, wherein the ink composition comprises a toner ink.

15. The coated label substrate as in claim 13, wherein the ink composition comprises a ribbon composition.

16. The coated label substrate as in claim 1, wherein the printable coating directly overlies the label substrate without any intermediate layer present between the printable coating and the label substrate.

17. The coated label substrate as in claim 1, wherein the connector is an adhesive layer overlying the second surface of the label substrate.

18. The coated label substrate as in claim 17 further comprising
a releasable sheet adjacent to the adhesive layer of the coated label substrate.

19. The coated label substrate as in claim 18, wherein the releasable sheet comprises a release layer and a base sheet, wherein the release layer is adjacent to the adhesive layer of the coated label substrate and is configured to facilitate separation of the releasable sheet and the coated label substrate to expose the adhesive layer.

20. A method of labeling a product with a coated label substrate, the method comprising
thermally printing an ink composition to an external surface of a coated label substrate formed by a printable coating, wherein the ink composition defines an image on the external surface, wherein the printable coating comprising an organic polymer covalently bonded to a plurality of inorganic nanoparticles, wherein the coated label substrate comprises a connector; and
connecting the coated label substrate to the product.
